(19) United States
(12) Patent Application Publication
(10) Pub. No.: US 2022/0168760 A1
(43) Pub. Date: Jun. 2, 2022

(54) SYSTEM FOR MOVING A PRODUCT APPLICATION NOZZLE

(71) Applicant: EXEL INDUSTRIES, EPERNAY (FR)

(72) Inventor: Benoît Batllo, Paris (FR)

(21) Appl. No.: 17/439,764

(22) PCT Filed: Mar. 20, 2020
(86) PCT No.: PCT/EP2020/057820

§ 371 Date: Sep. 15, 2021

(30) Foreign Application Priority Data
Mar. 20, 2019 (FR) FR1902884

(51) Int. Cl. B05B 3/14; B05C 5/02; B05B 3/02; B06B 1/04

(52) U.S. Cl. CPC B05B 3/14; B06B 1/04; B05B 3/02; B05C 5/02

(57) ABSTRACT

A system for moving a product application nozzle, including a flexible duct ending in a nozzle, and a magnetic device which has a plurality of permanent magnets fixed to the nozzle and a plurality of electromagnets placed at a distance around the permanent magnets of the nozzle, the magnetic device generating oscillations of the nozzle eccentrically with respect to a central axis of the system.

### CROSS-REFERENCE TO RELATED APPLICATIONS

This application claims benefit under 35 USC § 371 of PCT Application No. PCT/EP2020/057820 entitled SYSTEM FOR MOVING A PRODUCT APPLICATON NIOZZLE, filed on Mar. 20, 2020 by inventor Benoit Batllo. PCT Application No. PCT/EP2019/079555 claims priority of French Patent Application No. 19 02884, filed on Mar. 20, 2019.

### FIELD OF THE INVENTION

The present invention relates to a system for moving a product application nozzle.

### BACKGROUND OF THE INVENTION

To apply a spiralized or homogeneous bead of viscous product over a constant width (for example 10 to 30 mm) with a low thickness (for example less than 2 mm), it is necessary to set the product in motion at the outlet of a product application nozzle. This is valid for products such as sealants, glues or greases, in particular in the areas of sheet metal assembly, in the application of mastic sealing beads or more generally in the case of the application of a product whose viscosity is for example between 5000 and 1 million centipoise.

Systems for rotating the product during air flow or by offsetting the nozzle and a mechanical rotational movement are known. Air-based processes lack flexibility and stability, while mechanically offset nozzle systems using an electric motor have the drawbacks of high price, guide wear, and electric motor size.

It is these drawbacks that the invention intends to remedy by proposing a new system for setting a product application nozzle in motion, reducing the complexity, the price, the size and the wear of the parts of the system.

### SUMMARY OF THE DESCRIPTION

To this end, the invention relates to a system for setting in motion a nozzle for applying a product, comprising a flexible duct terminated by a nozzle. This system is characterized in that it further comprises a magnetic device comprising a plurality of permanent magnets attached to the nozzle and a plurality of electromagnets placed at a distance around the permanent magnets of the nozzle, wherein this magnetic device generates eccentric oscillations of the nozzle with respect to a central axis of the system.

Thanks to the invention, the magnetic operation removes friction and wear between moving parts and increases the life of the system. In addition, the absence of an electric motor reduces the cost and size of the system.

According to advantageous but non-mandatory aspects of the invention, such a system for setting in motion a nozzle for applying a product may incorporate one or more of the following characteristics, taken in any technically feasible combination:
Each of the electromagnets comprises an air gap and an electrically powered coil, and the air gap has a part extending radially opposite the permanent magnets of the nozzle.

The air gap has a damper located opposite the nozzle.

The electromagnets are energized in such a way that they all repel the permanent magnets or they all attract the permanent magnets.

The magnetic device comprises at least two permanent magnets distributed over a periphery of the nozzle and having the same polarity oriented towards an outer side, and at least two electromagnets disposed around the permanent magnets of the nozzle, and the electromagnets are electrically supplied out of phase so as to generate oscillations of the nozzle.

The magnetic device comprises three permanent magnets oriented at angles of 120° with respect to each other and three electromagnets oriented at angles of 120° with respect to each other.

The electromagnets are supplied electrically with a phase shift of 2π/3 radians.

The system comprises an air blowing device controlled so as to vary a product deposit diameter.

Each of the electromagnets is constructed so that the magnetic field lines that it generates traverse the permanent magnet located opposite and are oriented so as to oppose the magnetic field of the permanent magnet, and each electromagnet comprises an air gap having a central part located radially in front of the permanent magnet, and two side parts extending respectively above and below the permanent magnet, and a coil surrounding the central part or one of the side parts.

Each electromagnet also comprises at least two permanent magnets fixed on the lateral parts and located opposite, along a central axis of the nozzle, the permanent magnet being fixed to the nozzle, to oppose the magnetic field generated by the permanent magnet fixed to the nozzle even in the absence of a power supply to the electromagnets.

### BRIEF DESCRIPTION OF THE DRAWINGS

The invention will be better understood and other advantages thereof will appear more clearly in the light of the following description of a system for setting a product application nozzle in motion in accordance with its principle, made by way of a non-limiting example with reference to the accompanying drawings, in which:

FIG. 1 is a perspective view of a movement system according to the invention;

FIG. 2 is a cross-section of the system of FIG. 1;

FIG. 3 is a bottom view of the system of FIG. 1;

FIG. 4 is a partial schematic cross-section of the system of FIG. 1;

FIG. 5 is a side view of the system of FIG. 1 in operation;

FIG. 6 is a view similar to FIG. 5, of a system further comprising an air blower device;

FIG. 7 is a partial schematic cross-section of a system according to a second embodiment of the invention.

### DETAILED DESCRIPTION OF EMBODIMENTS

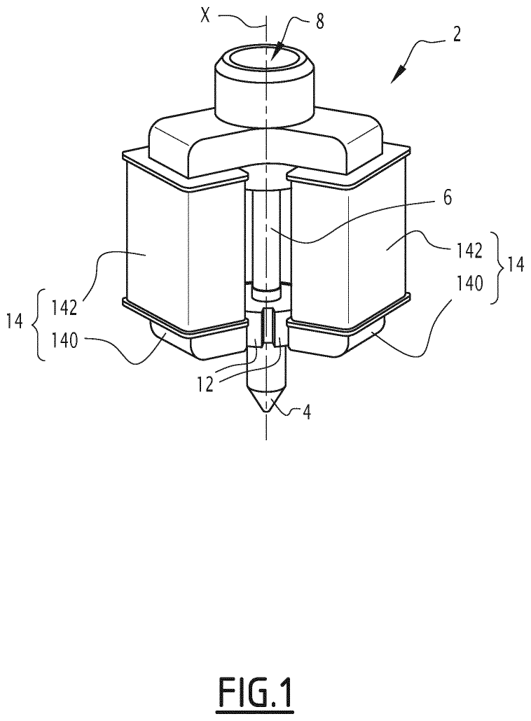

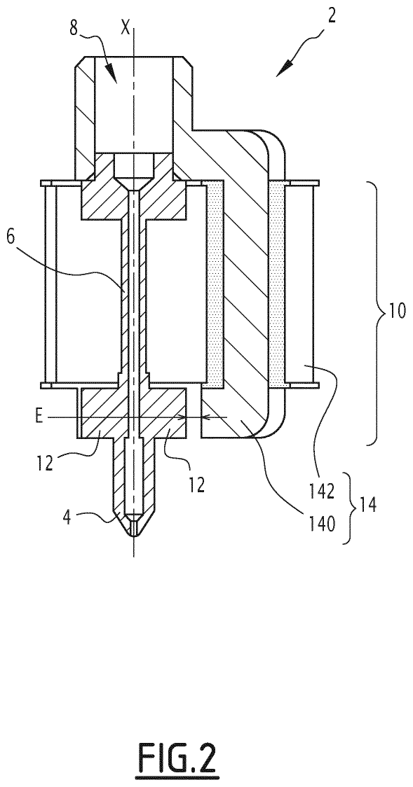

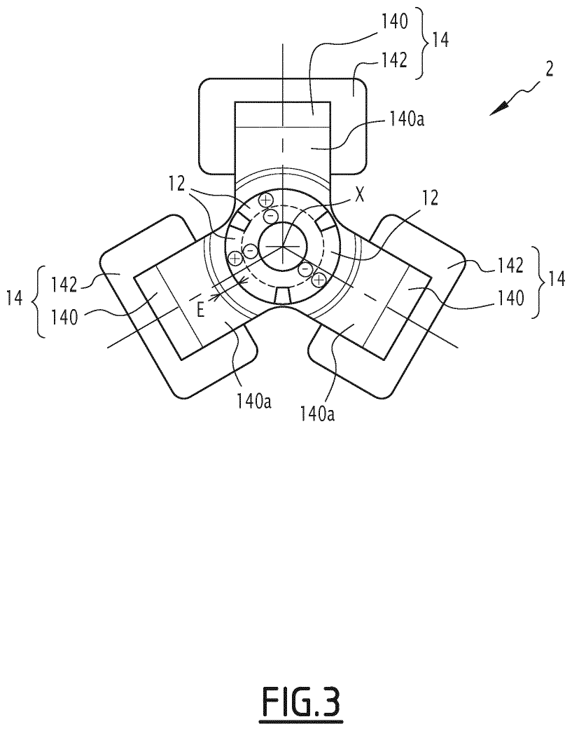

FIGS. 1 to 6 show a system 2 for setting in motion a nozzle 4 for applying a product. The system 2 is intended to be integrated into a machine for applying a viscous product, such as, among others, a mastic, an adhesive or a grease, in particular in the fields of sheet metal assembly, in the application of sealant beads. By viscous is meant a product whose viscosity is for example between 5000 and 1 million centipoise. Such viscous products must be set in motion, for example by a rotation, at the outlet of the nozzle 4, in order to obtain homogeneous and precise beads of the product.

The system 2 comprises a flexible duct 6 terminated by the nozzle 4. The system 2 comprises an orifice 8 for inputting the product to the flexible duct 6. The flexible duct 6 and the orifice 8 define a central axis X of the system 2.

The system 2 comprises a magnetic device 10 including a plurality of permanent magnets attached to the nozzle 4 and a plurality of electromagnets placed at a distance around the permanent magnets of the nozzle 4, wherein this magnetic device 10 generates eccentric oscillations of the nozzle 4 with respect to the central axis X of the system 2. By the expression “a plurality” is meant that the magnetic device 10 comprises at least two permanent magnets, and at least two electromagnets, i.e. at least two permanent magnet/electromagnet pairs.

In the example shown, the magnetic device 10 comprises three permanent magnets 12 distributed over a periphery of the nozzle 4 with each having the same polarity oriented towards an outer side, and three electromagnets 14 arranged around the permanent magnets 12 of the nozzle. 4. The electromagnets 14 are supplied electrically out of phase so as to generate oscillations of the nozzle 4 forming a circular oscillation along arrow F1 around the central axis X.

For example, the magnets 12 each have a negative (−) polarity oriented on the inner side, i.e. towards the central axis X, and a positive (+) polarity oriented on the outer side, i.e. opposite to the central axis X. As a variant, this configuration may be reversed. This configuration may also be transposed along the central axis X. In this case, the permanent magnets 12 distributed around the periphery of the nozzle 4 have a vertically oriented polarity while the electromagnets 14 create an opposite vertical polarity.

Each of the electromagnets 14 comprises an air gap 140, or fixed magnetic part, which may also be called an iron core, and an electrically powered coil 142. The air gap 140 has a part 140a extending radially opposite the permanent magnets 12 of the nozzle 4. The parts 140a are located at a radial distance E from the permanent magnets 12, in a deactivated configuration of the system 2 in which the flexible duct 6 and the nozzle 4 are aligned with the central axis X. When the system 2 is activated, i.e. when the electromagnets 14 are electrically supplied, the flexible duct 6 and the nozzle 4 are no longer aligned with the central axis X, and the distance E varies according to the oscillations of the nozzle 4.

By way of example, the permanent magnets 12 may together form a circular peripheral contour, centered on the central axis X in the deactivated configuration of the system 2. The parts 140a of the air gaps 140 may also each have an internal face of circular shape and concentric with the central axis X.

The electromagnets 14 are electrically supplied so that either all of them repel the permanent magnets 12, or all of them attract them, the aim being to generate a displacement of the permanent magnets 12 such that the nozzle is offset from the central axis X. In practice, the direction of the current in the coils 142 is chosen with respect to the polarities of the permanent magnets 12 which face them so as to obtain repulsion or attraction.

The coils 142 are electrically supplied by means of an electric current source (not shown). The electromagnets 14 are supplied with electric current with a phase shift of 2π/3 radians. The electrical phase shift varies as a function of the number of permanent magnet/electromagnet pairs of the magnetic device 10.

The electromagnets 14 are supplied electrically at a determined frequency which determines the speed of oscillation of the nozzle 4. This frequency may be, for example, between 200 Hz and 20 KHz. This oscillation frequency range must be greater than the natural frequency of the moving part formed by the nozzle 4 and the permanent magnets 12 so as to minimize the electromagnetic forces to be provided. For example, the magnetic force to be supplied by an electromagnet 14 may be between 15 N and 30 N, for a nozzle 4 whose mass is between 5 g and 10 g and which oscillates over an interval of ±250 μm around an axis of equilibrium at a frequency between 100 Hz and 200 Hz.

The three permanent magnets 12 are oriented at angles of 120° to each other, while the three electromagnets 14 are oriented at angles of 120° to each other.

In a variant not shown, the system 2 may comprise more than three pairs of permanent magnets 12/electromagnets 14, their angular orientation with respect to one another being adapted according to their number. In practice, for a given number of permanent magnets 12, the angular orientation of magnets 12 in degrees is equal to 360 divided by the number of magnets.

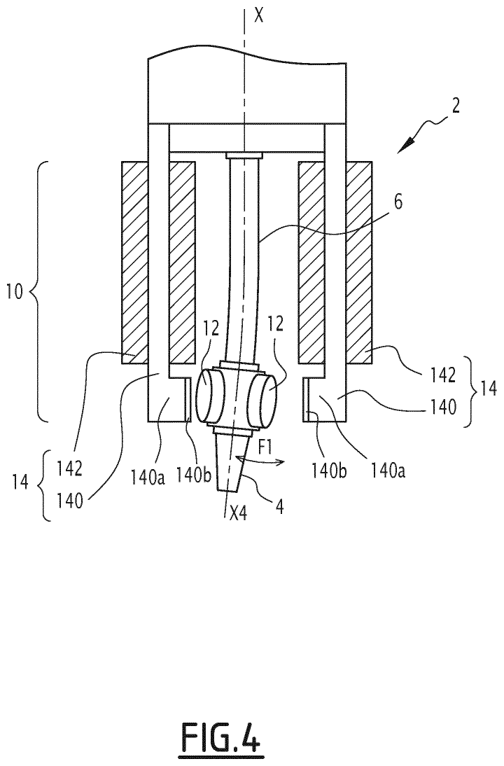

According to an optional aspect shown in FIG. 4, the air gap 140 may have a damper 140b located radially opposite the nozzle 4. This damper 140b aims to prevent too great a radial displacement of the nozzle 4 causing a collision with the part 140a of the air gap 140. This damper 140b may be, for example, made of an elastomeric material.

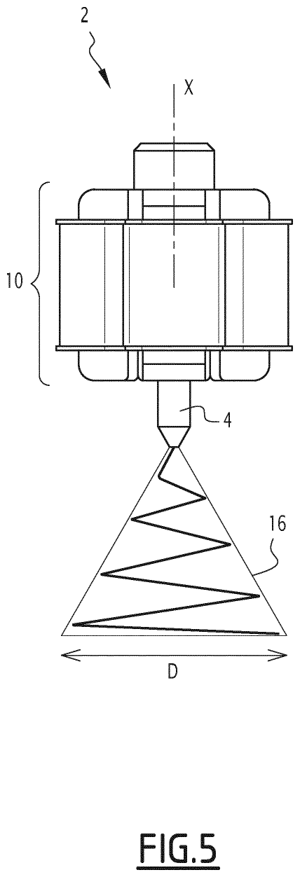

The circular oscillations described by the nozzle 4 may be characterized by a diameter D in FIG. 5. The diameter D is defined as the diameter of a base of a cone 16 of product deposited by the nozzle 4, and whose center is located on the central axis X.

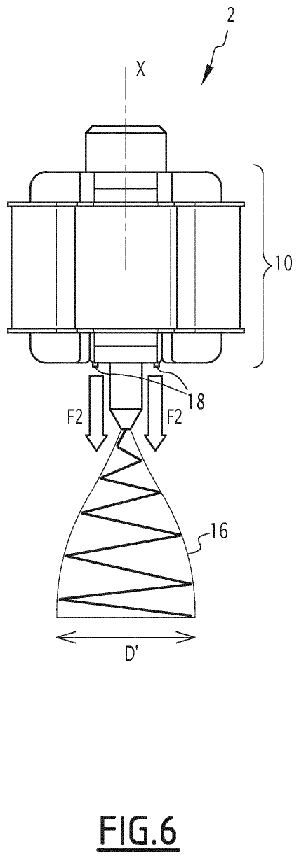

According to an optional aspect represented in FIG. 6, the system 2 may comprise an air blower device 18, this device 18 being controlled so as to vary the diameter of the deposit of the bead generated by the oscillation of the nozzle 4. For example, this device 18 may be formed by one or more air blowing nozzles supplied by a source (not shown) for supplying compressed air, and producing air jets F2 oriented for example in a direction parallel to the central axis X of the system 2 around the nozzle 4, so as to tighten the oscillations of the nozzle 4 around the central axis X, and consequently to tighten the cone 16. The cone 16 has in this case a base diameter D′ that is smaller than diameter D. This diameter D4 may be controlled by varying the operating parameters of the blowing device 18, for example, the pressure and/or the inclination with respect to the central axis X.

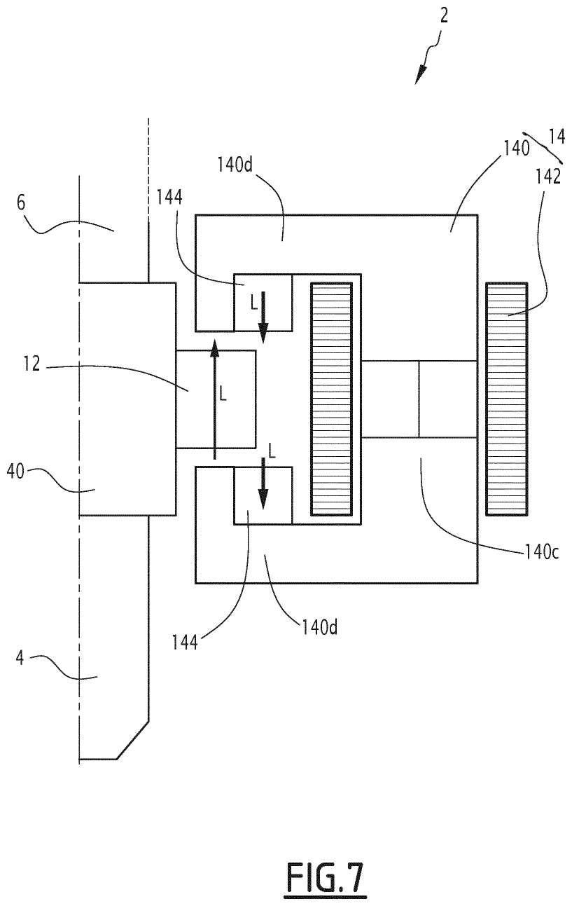

FIG. 7 shows a movement system according to a second embodiment of the invention. In this embodiment, the elements common to the first embodiment bear the same references and operate in the same way.

In this embodiment, the nozzle 4 is mounted on a non-magnetic nozzle holder 40, or tube, centered on the axis X4 of the nozzle 4. This nozzle holder 40, like the flexible duct 6, may be produced in a thermoplastic material, for example containing fibrous reinforcements to withstand the pressure of application of the product while being endowed with good flexibility.

On one side of this nozzle holder 40 is fixed one of the permanent magnets 12.

Each electromagnet 14 is constructed so that the field lines which it generates traverse the permanent magnet 12 located opposite on the nozzle 4 or the nozzle holder 40, and are oriented so as to oppose the magnetic field of the permanent magnet 12 located opposite. This increases the magnetic force obtained.

The electromagnet 14 located opposite the permanent magnet 12 may for example have a horseshoe structure. The air gap 140, or fixed magnetic part, or iron core, has a central part 140c located radially opposite the permanent magnet 12, and surrounded by the coil 142. The air gap 140 extends into two side parts 140d extending on either side of the central part 140c respectively above and below the permanent magnet 12. According to a variant not shown, the coil 142 may surround one of the side parts 140d instead of the central part 140c to improve the radial compactness of the system 2.

In this case, the electromagnet 14 may also include two permanent magnets 144 fixed to the side parts 140d and located opposite, along the central axis X4, the permanent magnet 12. The electromagnet 14 generates field lines L which are oriented downwards along the axis X4 traversing the permanent magnets 144 and oriented upwards along the axis X4 traversing the permanent magnets 12. The permanent magnets 144 generate a magnetic field opposing the magnetic field generated by the permanent magnet 12 fixed to the nozzle 4 even in the absence of a power supply to the electromagnets 14. This makes it possible to stabilize the nozzle 4 on the central axis X even when the electromagnets 14 are not supplied electrically.

In a variant not shown, each electromagnet 14 may include more than two permanent magnets 144.

The characteristics of the embodiments and variants described above may be combined to form new embodiments of the invention within the scope of the claims.

1. A system for setting in motion a nozzle for applying a product, comprising:
a flexible duct terminated by a nozzle; and
a magnetic device generating eccentric oscillations of said nozzle with respect to a central axis of the system, comprising:
a plurality of permanent magnets attached to said nozzle; and
a plurality of electromagnets placed at a distance around said permanent magnets.

2. The system according to claim 1, wherein each of said electromagnets comprises:
an air gap comprising a part extending radially opposite said permanent magnets of said nozzle; and
an electrically supplied coil.

3. The system according to claim 2, wherein said air gap comprises a damper located opposite said nozzle.

4. The system according to claim 1 wherein said electromagnets are supplied so that they all repel said permanent magnets, or all attract said permanent magnets.

5. The system according to claim 1, wherein said magnetic device comprises:
at least two permanent magnets distributed over a periphery of said nozzle and having the same polarity oriented towards an outer side; and
at least two electromagnets disposed around said permanent magnets, and wherein said electromagnets are supplied electrically out of phase so as to generate oscillations of said nozzle.

6. The system according to claim 5, wherein said magnetic device comprises:
three permanent magnets (12) oriented at angles of 120° relative to each other; and
three electromagnets oriented at angles of 120° relative to each other.

7. The system according to claim 6, wherein said electromagnets are supplied electrically with a phase shift of 2π/3 radians.

8. The system according to claim 1, further comprising an air blower device controlled so as to vary a diameter for depositing the product.

9. The system according to claim 1, wherein each of said electromagnets is constructed so that the magnetic field lines that it generates traverse one of said permanent magnets located opposite the electromagnet, is oriented so as to oppose the magnetic field of the permanent magnet, and comprises an air gap comprising:
a central part located radially opposite the permanent magnet; and
two side parts extending respectively above and below the permanent magnet and a coil surrounding said central part or one of the side parts.

10. The system according to claim 9, wherein each electromagnet further comprises at least two permanent magnets fixed on said side parts and located opposite, along a central axis of said nozzle, the one of said permanent magnet magnets, to oppose the magnetic field generated by the permanent magnet even in the absence of a power supply to said electromagnets.
